(19) United States
(12) Patent Application Publication
(10) Pub. No.: US 2025/0304286 A1
(43) Pub. Date: Oct. 2, 2025

(54) SOLENOID LAUNCH LOCK FOR A THRUST VECTOR CONTROL ACTUATOR

(71) Applicant: Honeybee Robotics, LLC, Longmont, CO (US)

(72) Inventor: Joseph Plunkett, Erie, CO (US)

(21) Appl. No.: 19/093,929

(22) Filed: Mar. 28, 2025

Related U.S. Application Data
(60) Provisional application No. 63/571,141, filed on Mar. 28, 2024.

(51) Int. Cl. B64G 1/40

(52) U.S. Cl. CPC B64G 1/40

(57) ABSTRACT

A lock assembly includes a motor rotor including a rotor surface; a solenoid including a winding portion extending toward the motor rotor; and a solenoid armature including an armature contact surface, the solenoid armature being positioned between the motor rotor and the winding portion and being movable along the axial direction between a locked position and an unlocked position. Each of the motor rotor and the solenoid armature include a set of castellated teeth configured to contact each other in the locked position to restrict a rotation of the motor rotor.

### CROSS-REFERENCE TO RELATED APPLICATIONS

This application claims priority to U.S. Provisional Application No. 63/751,141, filed on Mar. 28, 2024, the entire contents of which are hereby incorporated by reference.

### BACKGROUND

The subject matter disclosed herein relates in general to engine systems for spacecraft, and more particularly to locking systems for thrust vector control systems of spacecraft.

Certain spacecraft, such as landers (e.g., lunar landers, etc.) include engines for controlled landings and takeoffs from moons, planets, and the like. Such engines may include thrust vector control (TVC) systems which allow for adjustment to the direction of thrust from the engine or engines. Such TVC systems rely on precise motor movement at select times to turn, pivot, or otherwise move the engine. Accordingly, TVC systems include multiple sensitive and moving components.

In many instances, the lander is carried to a destination, such as the moon, by a separate transport vehicle, such as a rocket. Accordingly, the engines attached to the lander are not utilized during transport. While not in use, it may be beneficial to fix or lock the engine or engines in place. For instance, variables such as vibration and external loads can cause undesirable movement of the engine while in transport.

While existing locking mechanisms are suitable for their intended purposes the need for improvement remains, particularly in a locking assembly having the features described herein.

### BRIEF DESCRIPTION

According to one aspect of the present disclosure, a lock assembly is provided. The lock assembly may include a motor housing; a motor rotor rotatably provided within the motor housing, the motor rotor including a rotor surface; a solenoid coupled to the motor housing, the solenoid including a winding portion extending into the motor housing toward the motor rotor; and a solenoid armature provided within the motor housing and including an armature contact surface. The solenoid armature may be positioned between the motor rotor and the winding portion and may be movable along the axial direction between a locked position and an unlocked position. The lock assembly may further include a resilient member operably coupled between the solenoid and the solenoid armature. The resilient member may bias the solenoid armature toward the motor rotor.

According to another aspect of the present disclosure, a method of operating a lock assembly is provided. The lock assembly may include a motor rotor, a solenoid, and an armature. The method may include receiving an activation signal to move the armature from a locked position to an unlocked position, supplying an electrical current at an unlocking level to the solenoid for a predetermined length of time in response to receiving the activation signal, and reducing the supplied electrical current from the unlocking level to a holding level after the predetermined length of time.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 provides a schematic view of a thrust vector control (TVC) system according to exemplary embodiments of the present disclosure.

FIG. 2 provides an exploded perspective section view of a lock assembly for a TVC system according to exemplary embodiments of the present disclosure.

FIG. 3 provides a side section view of the exemplary lock assembly of FIG. 2 with an armature in a first position.

FIG. 4 provides a side section view of the exemplary lock assembly of FIG. 2 with the armature in a second position.

FIG. 5 provides an exploded view of a motor housing, a motor rotor, and an armature of a lock assembly according to exemplary embodiments of the present disclosure.

FIG. 6 provides a perspective view of a solenoid of the exemplary lock assembly of FIG. 2.

FIG. 7 provides a perspective view of a resilient member of the exemplary lock assembly of FIG. 2.

FIG. 8 provides a perspective view of an armature of the exemplary lock assembly of FIG. 2.

FIG. 9 provides a perspective view of a motor rotor of the exemplary lock assembly of FIG. 2.

FIG. 10 provides a flow chart illustrating a method of operating a lock assembly according to exemplary embodiments of the present disclosure.

### DETAILED DESCRIPTION

Embodiments disclosed herein provide for lock assemblies, particularly lock assemblies for use in selectively restricting adjustment or movement of a thrust vector control (TVC) system. The lock assembly may be operatively connected with a motor used to adjust a position, such as a thrust direction, of an engine of a spacecraft such as a lander. For instance, the motor may include a motor housing having a rotor provided therein and configured to selectively rotate a shaft. The shaft may be connected to an engine through a ball screw, for instance. Accordingly, when the motor is activated, the shaft may in turn rotate the ball screw to push or pull the engine in one of a plurality of direction.

Embodiments described herein include systems and assemblies for selectively or temporarily locking a rotation of the rotor such that the engine is maintained in a stationary position. The lock or locking assembly or system may include one or more features that physically restrict or prevent the rotation of the rotor when in a predetermined position.

Historically, certain braking systems have incorporated friction brakes to press a restrained element or piece against a rotational element of piece, such as along an axial direction. Such systems relied on heavy force loads to press the pieces together, resulting in high power draw and increased electricity required to operate.

In contrast, embodiments of the present disclosure provide include features which reduce power draw, reduce force required, and share force distribution when in a locked position. Advantageously, the embodiments described herein increase load holding capacity when locked and allow for easier movement from a locked position to an unlocked position.

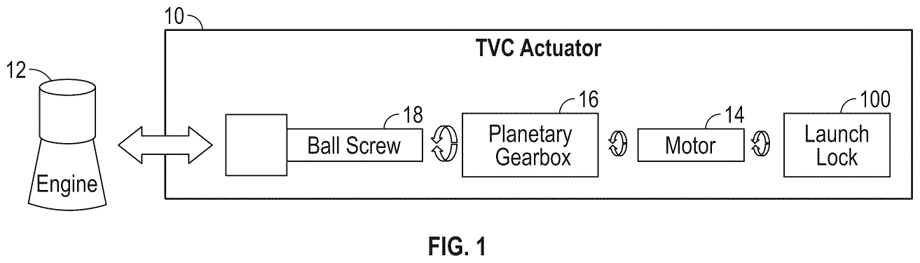

Turning now to the figures, FIG. 1 shows a schematic view of a thrust vector control (TVC) system or actuator 10 according to exemplary embodiments. TVC system 10 may be attached to or positioned within a spacecraft, such as a lander (e.g., lunar lander). TVC system 10 may be operably connected with an engine 12, such as a rocket engine. TVC system 10 may be configured to selectively adjust a position or direction of engine 12 according to a turning of a motor 14. For instance, motor 14 may be routed through a gearbox (such as a planetary gearbox) 16 and configured to turn a ball screw 18. Ball screw 18 may then be connected to engine 12 and push or pull engine 12 according to a direction of rotation of motor 14 and, in turn, ball screw 18.

TVC system 10 may include a lock assembly or launch lock 100. Lock assembly 100 may be operably connected with motor 14. For instance, lock assembly 100 may be positioned upstream of motor 14 (e.g., opposite gearbox 16). Lock assembly 100 may be configured to selectively lock or restrict a rotational output of motor 14 when adjusted to a predetermined position (e.g., locked position). As will be described, lock assembly 100 may selectively interact with a rotational element of motor 14 to maintain the rotational element in a stationary position.

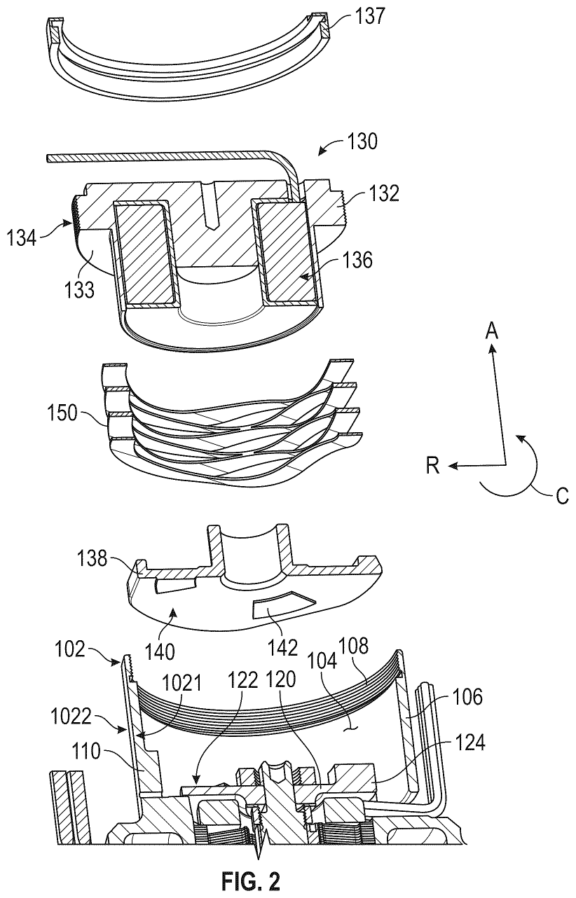

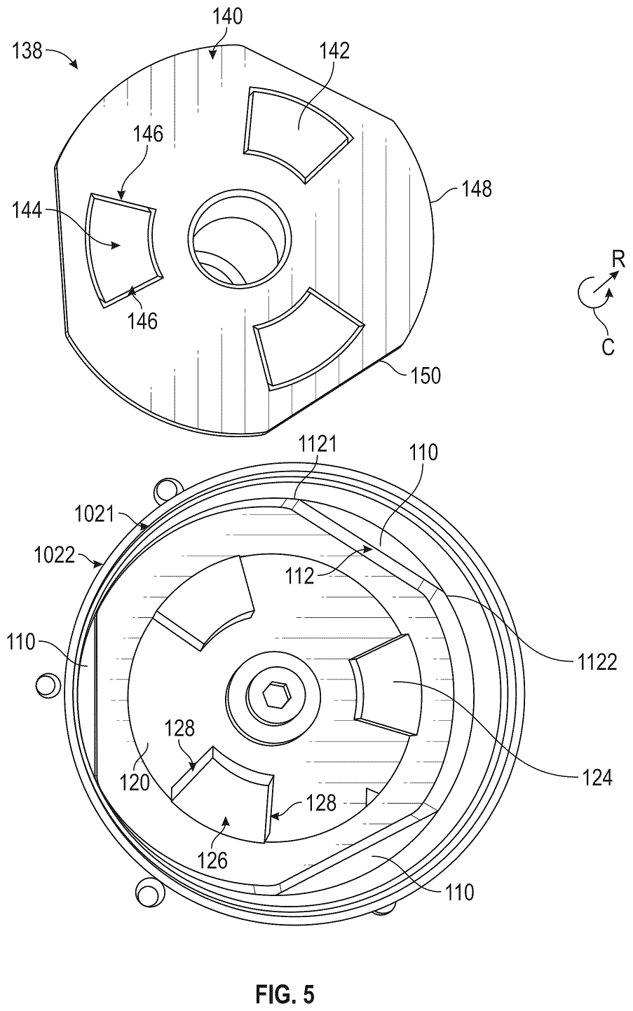

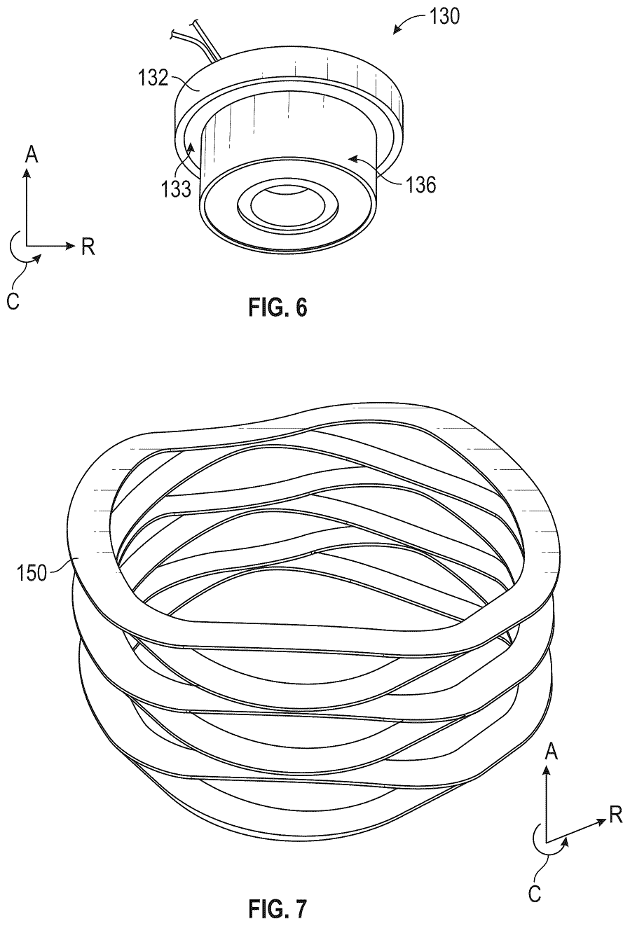

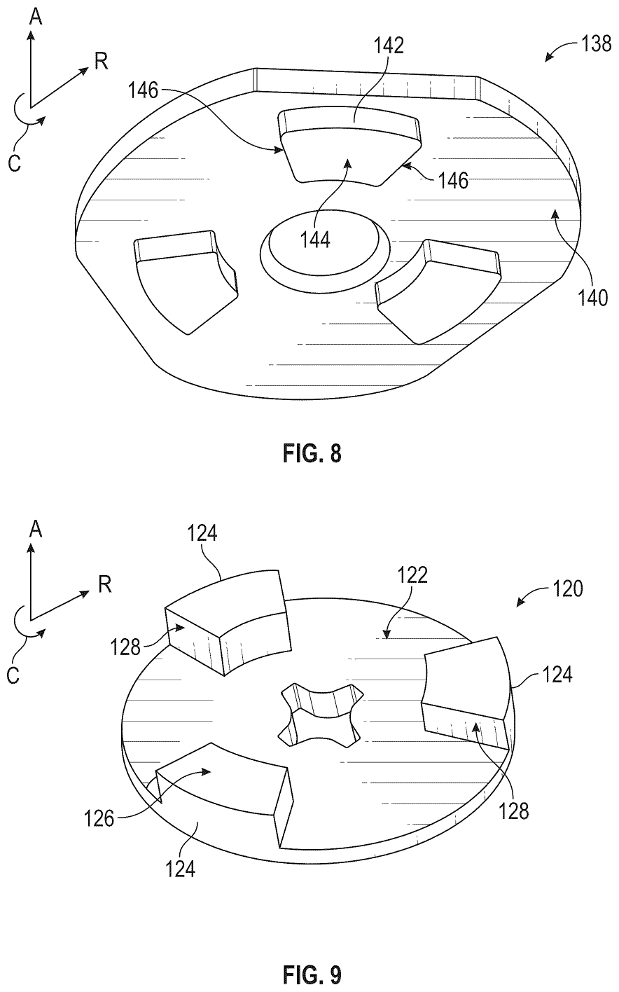

Referring now to FIGS. 2 through 9, views of lock assembly 100 are shown according to exemplary embodiments of the present disclosure. In particular, FIG. 2 provides an unassembled, perspective section view of components of lock assembly 100. Lock assembly 100 may define an axial direction A, a radial direction R, and a circumferential direction C. It should be noted, however, that lock assembly 100 may be orientated in any suitable direction and within any suitable coordinate system, and the coordinates defined herein are provided by way of example to describe relationship of parts with one another only.

Lock assembly 100 may include a housing 102. For purposes of discussion, housing 102 may be referred to as a motor housing. Motor housing 102 may define a receiving space 104 therein. For instance, motor housing 102 may include a circumferential wall 106 defining receiving space 104 therein. Thus, circumferential wall 106 may extend along the circumferential direction C and extend along the axial direction A. In some instances, motor housing 102 is attached with motor 14, however the disclosure is not limited to the examples provided herein. Motor housing 102 may define an inner surface 1021 and an outer surface 1022.

Motor housing 102 may include a threaded portion 108 formed therein. For instance, threaded portion 108 may be formed into inner surface 1021. Threaded portion 108 may be positioned at or near a top portion of circumferential wall 106 (e.g., along the axial direction A). Threaded portion 108 may extend to cover a predetermined distance of inner surface 1021. According to some examples, thread 108 covers between about 15% and about 25% of a total axial depth of inner surface 1021.

Motor housing 102 may include a key protrusion 110. In some instances, motor housing 102 includes a plurality of key protrusions 110. For one example, motor housing 102 includes three key protrusions 110. Each of the plurality of key protrusions 110 may be equidistant from each other. For instance, the plurality of key protrusions 110 may be spaced apart along the circumferential direction A. Additionally or alternatively, each key protrusion 110 may protrude or extend from inner surface 1021 (e.g., toward a radial center of motor housing 102). Hereinafter, a single key protrusion 110 will be described in detail with the understanding that the description may apply to each included key protrusion 110 according to specific embodiments.

As mentioned, key protrusion 110 may extend inward along the radial direction R (e.g., from inner surface 1021). Moreover, key protrusion 110 may define a linear lock face 112. Linear lock face 112 may extend perpendicular to the radial direction R. Additionally or alternatively, linear lock face 112 may extend perpendicular to the axial direction A. Referring briefly to FIG. 5, for instance, linear lock face 112 may define a first edge 1121 and a second edge 1122. Each of first edge 1121 and second edge 1122 may extend along the axial direction A. Linear lock face 112 may thus extend between the first edge 1121 and the second edge 1122 (e.g., in a straight line).

First edge 1121 may be positioned, provided, or otherwise defined at a first point of inner surface 1021. Likewise, second edge 1122 may be positioned, provided, or otherwise defined at a second point of inner surface 1021. As best shown in FIG. 5, linear lock face 112 may thus form a keyed portion within motor housing 102 (e.g., within receiving space 104) along an otherwise curved or cylindrical inner surface 1021. In some instances, linear lock face 112 of key protrusion 110 may be described as a tangential surface tangential to motor housing 102 and spaced radially inward from inner surface 1021 by a predetermined distance.

Lock assembly 100 may include a motor rotor 120. In detail, motor rotor 120 may be operably connected with or at motor 14. Motor rotor 120 may be selectively rotated by motor 14 when an adjustment of engine 12 is requested or commanded. Thus, motor rotor 120 may be provided within motor housing 102. Motor rotor 120 may be rotatable within motor housing 102 (e.g., with respect to motor housing 102).

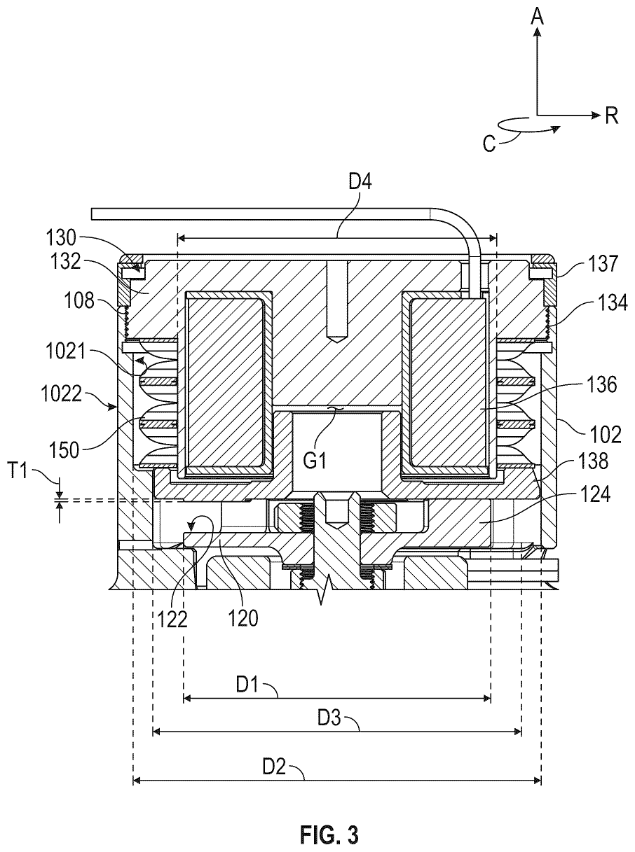

Motor rotor 120 may have a predetermined rotor diameter DI (FIG. 3). Rotor diameter D1 of motor rotor 120 may be less than an inner diameter D2 of circumferential wall 106 of motor housing 102. Additionally or alternatively, rotor diameter D1 may be less than a virtual diameter D3 formed by radially inward points of key protrusions 110. As mentioned above, a plurality (e.g., three or more) key protrusions 110 may be included according to some embodiments. As shown particularly in FIG. 5, radially innermost points of each key protrusion 110 may define virtual diameter D3. Rotor diameter DI may thus be less than virtual diameter D3 such that motor rotor 120 is free to rotate within motor housing 102 without interference from key protrusions 110.

Motor rotor 120 may include or define a rotor surface 122. For instance, rotor surface 122 may face the axial direction A. According to some embodiments, rotor surface 122 is orientated to face upward along the axial direction A (e.g., toward an axial top of motor housing 102). Rotor surface 122 may include at least one rotor protrusion 124. For instance, the at least one rotor protrusion 124 may protrude or extend from rotor surface 122 along the axial direction A (e.g., upward along the axial direction A). According to some embodiments, a plurality of rotor protrusions 124 are included. Hereinafter, a single rotor protrusion 124 will be described in detail with the understanding that the description may apply to any suitable number of rotor protrusions 124 included, according to specific embodiments.

Rotor protrusion 124 may have a predefined shape. For instance, rotor protrusion 124 may be semi-wedge shaped. Thus, rotor protrusion 124 may have a radial length and an angular circumferential span. As shown particularly in FIGS. 5 and 9, the radial length of rotor protrusion 124 (e.g., along the radial direction R) may be between about 30% and about 50% of a total radius of motor rotor 120. Further, the angular circumferential span of rotor protrusion 124 (e.g., along the circumferential direction C) may be between about 25 degrees and about 40 degrees. However, it should be understood that the ranges described herein are provided by way of example only, and that rotor protrusion 124 may have or define any suitable dimensions.

Rotor protrusion 124 may define an axial rotor face 126 and a radial rotor face 128. According to some embodiments, rotor protrusion 124 defines two radial rotor faces 128 (as would be expected). Axial rotor face 126 may face the axial direction A (e.g., upward along the axial direction A). Thus, axial rotor face 126 may extend along the radial direction R and the circumferential direction C. Radial rotor face 128 may extend along the radial direction R and the axial direction A. Thus, radial rotor face 128 may face the circumferential direction C. Radial rotor face 128 may connect axial rotor face 126 with rotor surface 122.

Lock assembly 100 may include a solenoid 130. Solenoid 130 may be at least partially received within motor housing 102. For instance, solenoid 130 may include a solenoid housing 132. Solenoid housing 132 may be selectively coupled to motor housing 102. According to some embodiments, solenoid housing 132 is threadedly coupled to motor housing 102 (e.g., at threaded portion 108). Thus, solenoid housing 132 may include a solenoid thread 134 formed into an outer circumferential surface thereof. Solenoid thread 134 may be configured to mate with threaded portion 108 of motor housing such that solenoid 130 is secured to motor housing 102.

Solenoid 130 may include a winding portion 136. Winding portion 136 may extend from solenoid housing 132 along the axial direction A. For instance, with reference to FIGS. 2 through 4, winding portion 136 may extend downward along the axial direction A into motor housing 102. Thus, winding portion 136 may have a winding diameter D4. Winding diameter D4 may be less than inner diameter D2 of motor housing 102, and subsequently, less than a diameter of solenoid housing 132. Additionally or alternatively, winding portion 136 may be predominantly cylindrical. As would be understood, winding portion 136 may be configured to receive an electrical input to produce an electrical or magnetic field.

According to some embodiments, lock assembly 100 includes a jam nut 137. Jam nut 137 may selectively couple to motor housing 102 adjacent to solenoid 130. For instance, jam nut 137 may be pressed over solenoid 130 toward motor housing 102 after solenoid 130 is attached to motor housing 102 (e.g., via thread 134). Accordingly, jam nut 137 may be predominantly cylindrical to match motor housing 102. Additionally or alternatively, jam nut 137 may include one or more gaskets (not shown) to provide a seal with respect to solenoid housing 132.

Lock assembly 100 may include a solenoid armature 138. Solenoid armature 138 may be provided within motor housing 102. For instance, solenoid armature 138 may be movable within motor housing 102. For example, solenoid armature 138 is configured to reciprocate within motor housing 102 along the axial direction A. Solenoid armature 138 may be positioned between winding portion 136 of solenoid 130 and motor rotor 120. As will be described, solenoid armature 138 may be movable between a locked position and an unlocked position with respect to motor rotor 130.

Solenoid armature 138 may include an armature contact surface 140. Armature contact surface 140 may face the axial direction A. For instance, armature contact surface 140 may face toward rotor surface 122 (e.g., downward, or in an opposite direction from the jam nut 137 end, along the axial direction A). Solenoid contact surface 140 may include an armature protrusion 142. Armature protrusion 142 may protrude along the axial direction A (e.g., toward motor rotor 120). According to some embodiments, multiple armature protrusions 142 may be included. For instance, three armature protrusions 142 may be included. For instance, a plurality of armature protrusions 142 may be spaced apart from each other about the circumferential direction C.

Armature protrusion 142 may have a height or thickness T1 along the axial direction A. For instance, armature protrusion 142 may define an axial armature face 144 and a radial armature face 146. Axial armature face 144 may be predominantly parallel with armature contact surface 140. Thus, the thickness T1 may be defined between armature contact surface 140 and axial armature face 144. According to some embodiments, the thickness T1 is between about 0.2 millimeters (mm) and 0.3 mm. However, it should be understood that these ranges are provided by way of example only and that armature protrusion 142 may have any suitable thickness.

According to some embodiments, armature protrusion 142 defines two radial armature faces 146 (as would be expected). As mentioned, axial armature face 144 may face the axial direction A (e.g., downward along the axial direction A). Thus, axial armature face 144 may extend along the radial direction R and the circumferential direction C. Radial armature face 146 may extend along the radial direction R and the axial direction A. Thus, radial armature face 146 may face the circumferential direction C. Radial armature face 146 may connect axial armature face 144 with armature contact surface 140.

Solenoid armature 138 may be rotationally locked or restricted within motor housing 102. Referring briefly to FIG. 5, solenoid armature 138 may define a circumferential edge 148. Circumferential edge 148 may be predominantly circular (i.e., corresponding to inner surface 1021 of motor housing 102). At least a portion of circumferential edge 148 may be linear. For instance, circumferential edge 148 may be notched to form a linear portion 150. Linear portion 150 may correspond with key protrusion 110 (e.g., with linear lock face 112). Advantageously, solenoid armature 138 may be restricted from rotating within motor housing 102.

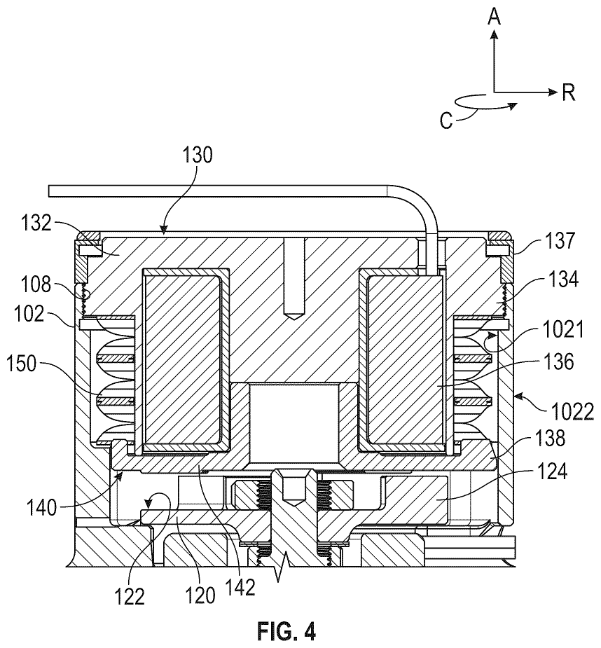

Solenoid armature 138 may be configured to interact with motor rotor 120. As mentioned, solenoid armature 138 may move (e.g., reciprocate, translate, etc.) between a locked position (e.g., FIG. 3) and an unlocked position (e.g., FIG. 4). When in the locked position, solenoid armature 138 may be in contact with motor rotor 120. In detail, armature contact surface 140 may be in planar contact with axial rotor face 126 when solenoid armature 138 is in the locked position. Additionally or alternatively, radial rotor face 124 may be in planar contact with radial armature face 144 when solenoid armature 138 is in the locked position. Advantageously, rotational forces from motor rotor 120 may be restricted along the circumferential direction C by armature protrusion 142 (e.g., at radial armature face 142).

Solenoid armature 138 may be formed from a predetermined magnetic alloy. For instance, solenoid armature 138 may include a cobalt-iron alloy. As would be understood, solenoid armature 138 includes one or more elements configured to react to a magnetic or electronic field (e.g., as generated by solenoid 130). Further, as mentioned, solenoid armature 138 is configured to restrict a rotational movement of motor rotor 120 when in the locked position. Accordingly, solenoid armature 138 may include a core portion including a soft magnetic alloy (e.g., cobalt-iron) and a shell portion including a hard or relatively hard material or composite. Advantageously, solenoid armature 138 may be moved (e.g., from the locked position to the unlocked position) via magnetic generation from solenoid 130 while retaining stiffness in, for instance, armature protrusion 142 to effectively resist the rotation of motor rotor 120.

Lock assembly 100 may include a resilient member 150. Resilient member 150 may be operably coupled between solenoid 130 and solenoid armature 138. For instance, resilient member 150 may bias solenoid armature 138 away from solenoid 130 (e.g., along the axial direction A). Thus, resilient member 150 may bias solenoid armature 138 toward motor rotor 120. Resilient member 150 may bias or push solenoid armature 138 toward the locked position. Accordingly, resilient member 150 may be or include a spring member, such as a wave spring, a compression spring, or the like.

According to some embodiments, resilient member 150 is positioned around winding portion 136 of solenoid 130. In detail, solenoid housing 132 may include an axial housing face 133. Axial housing face 133 may face downward along the axial direction A (e.g., toward motor rotor 120). Resilient member 150 may thus contact axial housing face 133. Accordingly, resilient member 150 may be in contact with a top or top surface of solenoid armature 138 (e.g., opposite armature contact surface 140). However, according to some embodiments, resilient member 150 may be positioned within, or radially inward from, winding portion 136. As mentioned, winding portion 136 may be predominantly cylindrical. Additionally or alternatively, multiple resilient members 150 may be included according to specific embodiments, and the disclosure is not limited to the examples provided herein.

Resilient member 150 may be configured to maintain solenoid armature 138 in the locked position (e.g., in contact with motor rotor 120). Solenoid 130 may be selectively initiated, activated, or otherwise powered at a predetermined time. When activated, solenoid armature 138 may be attracted toward winding portion 136. As such, an attraction force generated at winding portion 136 may be greater than a spring force generated by resilient member 150. Solenoid 130 may thus be supplied with an unlocking level of electrical current upon initiation. According to some embodiments, the unlocking level of electrical current is between about 200 milliamperes (mA) and 250 mA. However, it should be understood that the unlocking level of electrical current may vary according to a spring force of resilient member 150. Solenoid armature 138 may then be moved to the unlocked position. When in the unlocked position, motor rotor 120 may be free to rotate within motor housing 102 (i.e., unencumbered or unrestrained by armature protrusion 142).

When solenoid armature 138 is in the locked position (e.g., in contact with motor rotor 120), a predetermined air gap distance Gl may be formed between solenoid armature 138 and solenoid 130. For instance, referring to FIG. 3, solenoid armature 138 is in the locked position and spaced apart from solenoid 130 by the predetermined air gap distance G1. The predetermined air gap distance G1 may be determined based on a spring force of resilient member 150, a magnetic power of solenoid 130, and a weight or mass of solenoid armature 138. According to at least some embodiments, the predetermined air gap distance G1 is between about 0.3 mm and about 0.7 mm. However, the ranges described herein are provided by way of example only, and that any suitable air gap distance may be utilized according to specific embodiments.

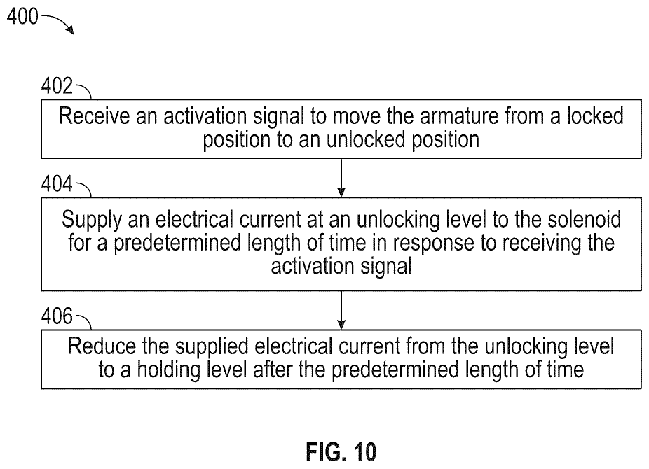

Now that a lock assembly for a thrust vector control system has been described in detail, a method 400 of operating a lock system will be described in detail with reference to FIG. 10. Method 400 may be applicable to lock assembly 100 described above, or any other suitable locking system, mechanism, or assembly capable of selectively restricting motion of a motor or motor rotor. It should be understood that method 400 may include additional steps or may omit one or more of the steps recited herein according to specific applications. Hereinafter, method 400 will be described with reference to a lock assembly (e.g., lock assembly 100) including a motor rotor (e.g., motor rotor 120), a solenoid (e.g., solenoid 130), and an armature (e.g., solenoid armature 138).

At 402, method 400 may include receiving an activation signal to move the armature from a locked position to an unlocked position. As mentioned above, the armature may be movable between the locked position (e.g., in contact with the motor rotor to restrict rotation) and the unlocked position (e.g., to allow free rotation of the motor rotor). The activation signal may be an automatic signal, such as a sensor indication of an engine activation, or a manual signal, such as a control input from a user (e.g., astronaut).

At 404, method 400 may include supplying an electrical current at an unlocking level to the solenoid for a predetermined length of time in response to receiving the activation signal. In detail, the activation signal may be received and interpreted by a controller coupled with the solenoid and a power source operably coupled with the solenoid. The power source may then provide the electrical current to the solenoid at the unlocking level. According to some embodiments, the unlocking level may be between about 200 milliamperes (mA) and about 250 mA. However, the unlocking level current may vary according to specific embodiments, and the disclosure is not limited to the examples provided herein.

As mentioned, the unlocking level may be supplied for a predetermined length of time. In some instances, the predetermined length of time is less than 1 second. Because the armature is spaced away from the solenoid by a predetermined distance (e.g., about 0.5 mm), a higher power level is used to attract the armature from the distance toward the solenoid. Accordingly, in some embodiments the unlocking level may be directly correlated with the predetermined distance (e.g., air gap) between the armature and the solenoid.

At 406, method 400 may include reducing the supplied electrical current from the unlocking level to a holding level after the predetermine length of time. At the unlocking level, the armature may move toward the solenoid such that the air gap is closed relatively quickly (e.g., less than 1 second). At such a point, the solenoid may become more efficient, thus requiring less power to maintain the armature in the unlocked position. Accordingly, the holding level may be between about 40 mA and about 60 mA (e.g., depending on vibration level or other environmental factors or disturbances).

The lock assembly may include a resilient member (e.g., resilient member 150). As mentioned above, the resilient member may bias the armature away from the solenoid (e.g., toward the motor rotor or toward the locked position). Accordingly, the holding level may be determined according to a force (e.g., a spring force) exerted on the armature by the resilient member. Additionally or alternatively, each of the unlocking level and the holding level may be based at least in part on a mass of the armature. Accordingly, it should be understood that the ranges described herein are provided by way of example only, and that higher or lower values for each of the unlocking level and the holding level may be incorporated into specific embodiments.

Method 400 may include receiving a deactivation signal to move the armature from the unlocked position to the locked position. For instance, upon a determination that the engine to which the lock assembly is attached is no longer in use, the deactivation signal may be provided to relock the motor rotor. Similar to the activation signal, the deactivation signal may be an automatic signal or a manual signal. Upon receiving the deactivation signal, method 400 may include ceasing the supply of the electrical current to the solenoid. Thus, the power source may be deactivated such that no power is provided to the solenoid and thus no electrical or magnetic field is generated within lock assembly.

Method 400 may include moving the armature into contact with the motor rotor (e.g., from the unlocked position to the locked position) after ceasing the supply of the electrical current. As mentioned above, the lock assembly may include a resilient member (e.g., such as a wave spring, a compression spring, etc.). When the power supply or electrical current supply is ceased or otherwise stopped, the resilient member may bias the armature toward the motor rotor. In some instances, the armature may be pushed, biased, or otherwise moved toward the motor rotor by additional or alternative means, such as a separate motor, an extension spring, a lever, etc. Accordingly, the lock assembly may be returned to the locked position to restrict a rotational motion of the motor rotor.

The detailed description explains embodiments of the disclosure, together with advantages and features, by way of example with reference to the drawings.

The term “about” is intended to include the degree of error associated with measurement of the particular quantity based upon the equipment available at the time of filing the application.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A lock assembly defining an axial direction, a radial direction, and a circumferential direction, the lock assembly comprising:
a motor housing;
a motor rotor rotatably provided within the motor housing, the motor rotor comprising a rotor surface;
a solenoid coupled to the motor housing, the solenoid comprising a winding portion extending into the motor housing toward the motor rotor;
a solenoid armature provided within the motor housing and comprising an armature contact surface, the solenoid armature being positioned between the motor rotor and the winding portion and being movable along the axial direction between a locked position and an unlocked position; and
a resilient member operably coupled between the solenoid and the solenoid armature, wherein the resilient member biases the solenoid armature toward the motor rotor.

2. The lock assembly of claim 1, wherein the rotor surface comprises:
a first rotor protrusion protruding along the axial direction toward the solenoid armature, the first rotor protrusion defining an axial rotor face and a radial rotor face.

3. The lock assembly of claim 2, wherein the armature contact surface comprises:
a first armature protrusion protruding along the axial direction toward the motor rotor, the first armature protrusion defining an axial armature face and a radial armature face.

4. The lock assembly of claim 3, wherein the radial rotor face is in planar contact with the radial armature face and the axial rotor face is in planar contact with the armature contact surface when the solenoid armature is in the locked position.

5. The lock assembly of claim 3, wherein a height of the first armature protrusion is between 0.2 mm and 0.3 mm.

6. The lock assembly of claim 3, wherein the rotor surface further comprises a second rotor protrusion and a third rotor protrusion, wherein the first rotor protrusion, the second rotor protrusion, and the third rotor protrusion are spaced equidistant from each other about the circumferential direction.

7. The lock assembly of claim 3, wherein the armature contact surface further comprises a second armature protrusion and a third armature protrusion, wherein the first armature protrusion, the second armature protrusion, and the third armature protrusion are spaced equidistant from each other about the circumferential direction.

8. The lock assembly of claim 1, wherein the solenoid armature is spaced apart from the winding portion along the axial direction by a predetermined air gap distance when in the locked position.

9. The lock assembly of claim 8, wherein the predetermined air gap distance is between 0.3 millimeters (mm) and 0.7 mm.

10. The lock assembly of claim 1, wherein the solenoid further comprises:
a solenoid housing, wherein the winding portion extends from the solenoid housing along the axial direction, and wherein a diameter of the winding portion is less than a diameter of the solenoid housing such that the solenoid housing defines an axial housing face.

11. The lock assembly of claim 10, wherein the resilient member is a wave spring positioned around the winding portion along the circumferential direction, the wave spring being in contact with the axial housing face and a top of the solenoid armature.

12. The lock assembly of claim 1, wherein the motor housing comprises:
at least one key protrusion extending inward along the radial direction, the at least one key protrusion defining a linear lock face extending perpendicular to the radial direction and the axial direction, wherein the at least one key protrusion is positioned proximate the motor rotor.

13. The lock assembly of claim 12, wherein at least a portion of a circumferential edge of the solenoid armature is linear corresponding to the linear lock face such that the solenoid armature is rotationally restrained within the motor housing along the circumferential direction.

14. The lock assembly of claim 13, wherein the at least one key protrusion comprises a plurality of key protrusions spaced equidistant about the circumferential direction.

15. The lock assembly of claim 1, wherein the solenoid armature is formed from a cobalt-iron alloy.

16. The lock assembly of claim 1, wherein the resilient member is configured to maintain the solenoid armature in the locked position when the solenoid is inactive, and wherein the solenoid attracts the solenoid armature to the unlocked position against the resilient member when the solenoid is activated.

17. A method of operating a lock assembly, the lock assembly comprising a motor rotor, a solenoid, and an armature, the method comprising:
receiving an activation signal to move the armature from a locked position to an unlocked position;
supplying an electrical current at an unlocking level to the solenoid for a predetermined length of time in response to receiving the activation signal; and
reducing the supplied electrical current from the unlocking level to a holding level after the predetermined length of time.

18. The method of claim 17, wherein the unlocking level of the electrical current is between 200 milliamperes (mA) and 250 mA, and wherein the holding level of the electrical current is between 40 mA and 60 mA.

19. The method of claim 17, further comprising:
receiving a deactivation signal to move the armature from the unlocked position to the locked position;
ceasing the supply of the electrical current to the solenoid in response to receiving the deactivation signal; and
moving the armature into contact with the motor rotor after ceasing the supply of the electrical current.

20. The method of claim 19, wherein the lock assembly further comprises a resilient member biasing the armature toward the motor rotor.
